(19) United States
(12) Patent Application Publication
(10) Pub. No.: US 2026/0055027 A1
(43) Pub. Date: Feb. 26, 2026

(54) POLYMER POWDERS REDISPERSIBLE IN WATER FOR DRY CONSTRUCTION MATERIAL FORMULATIONS

(71) Applicant: Wacker Chemie AG, Munich (DE)

(72) Inventors: Markus BANNWARTH, München (DE); Peter FRITZE, München (DE); Klas SORGER, München (DE)

(73) Assignee: Wacker Chemie AG, Munich (DE)

(21) Appl. No.: 19/105,826

(22) PCT Filed: Aug. 31, 2023
(86) PCT No.: PCT/EP2023/073895

§ 371 Date: Feb. 24, 2025

Related U.S. Application Data
(63) Continuation-in-part of application No. PCT/EP2022/074750, filed on Sep. 6, 2022.

(51) Int. Cl. C04B 24/26; C04B 111/00; C08F 210/02; C08F 218/08

(52) U.S. Cl. CPC C04B 24/2623; C08F 210/02; C08F 218/08; C04B 2111/00637

(57) ABSTRACT

A process for producing protective-colloid-stabilized polymers based on ethylenically unsaturated monomers in the form of water-redispersible powders,
by producing aqueous dispersions of protective-colloid-stabilized polymers based on ethylenically unsaturated monomers by polymerization of one or more ethylenically unsaturated monomers in an aqueous medium and drying said dispersions in the presence of one or more drying aids. The drying aids include a) one or more inorganic salts selected from the group of alkali metal sulfates and alkali metal sulfites and b) optionally one or more water-soluble organic polymers. The inorganic salts a) are present in the aqueous dispersions of the protective-colloid-stabilized polymers based on ethylenically unsaturated monomers in dissolved form after all drying aids have been added. The inorganic salts a) are employed as drying aids to an extent of ≥25% by weight based on the total weight of the drying aids.

The invention relates to processes for producing polymers in the form of water-redispersible powders with addition of alkali metal sulfates or alkali metal sulfites, to the polymer powders thereby obtainable, and to the use thereof for example in building material dry formulations, such as tile adhesives, sealing slurries, self-leveling compositions or reinforcing compositions.

Polymers in the form of water-redispersible powders (polymer powders) refer, as is known, to powder compositions obtainable by drying the corresponding aqueous polymer dispersions in the presence of drying aids. This production process results in the finely divided polymer resin in the dispersion becoming coated with usually water-soluble drying aids. During drying, the drying aid acts as a jacket that prevents the particles from sticking together irreversibly. On redispersion of the polymer powders in water, the drying aid dissolves and an aqueous redispersion forms in which the original polymer particles (polymer primary particles) are as far as possible present once again (Schulze J. in TIZ, No. 9, 1985).

In the quest to furnish polymer powders with such redispersible properties, there have in the past been developments in many different directions and a number of different drying aids have become established, water-soluble organic polymers in particular. Thus, U.S. Pat. No. 5,567,750 for example teaches polyvinyl alcohols as drying aids. U.S. Pat. No. 5,874,524 recommends for this purpose polyelectrolytes and EP0078449 vinylpyrrolidone-vinyl acetate polymers or alkali metal or alkaline earth metal salts of naphthalenesulfonic acid-formaldehyde condensates. Such naphthalenesulfonic acid-formaldehyde condensates are also disclosed in EP407889. Starch (derivatives) have likewise been used many times as drying aids, as described in EP134451.

Polymer powders are widely used as additives for building material dry formulations based on hydraulically setting binders, especially cement, and also fillers and additives as described in US2007037925, for example for use as tile adhesives, joint fillers, spackling compounds, sealing slurries, plaster or screed. Adding polymer powders to building material dry formulations makes it possible, for example, to improve the cohesive or adhesive properties of the hardened building products, in particular their mechanical strength, such as tensile adhesion strengths.

The tensile adhesion strengths of building products are however reduced by the action of heat. Solar radiation and also underfloor heating expose building products to thermal stress, which results in mechanical stresses in the building product and weakens the tensile adhesion strength of the building products. Building products need to withstand such thermal stresses over their entire service life, spanning many years. The tensile adhesion strength of building products after heat aging is an important measure of their resilience to thermal stresses. With standard polymer powders, although it is possible to achieve an improvement in tensile adhesion strengths after heat aging, there is a need, against the background also of climate change and use of the polymer-modified building material formulations in warmer countries, to further improve tensile adhesion strengths after heat aging and to achieve this in the most efficient way possible, especially when only small amounts of polymer powder are used.

Against this background, the object was to improve the tensile adhesion strengths of building products after heat aging. This should preferably be achieved in the most efficient way possible, especially when only small amounts of polymer powder are used.

Surprisingly, the object was achieved with polymer powder produced using alkali metal sulfates or alkali metal sulfites as drying aids alone or in a significant proportion and with ≤40% by weight of water-soluble organic polymers added as drying aids, based on the total weight of said water-soluble organic polymers and protective colloids. This was particularly surprising, given that the water-soluble organic polymers established as drying aids to date also have binder properties with a positive influence on tensile adhesion strengths, whereas the invention employs as drying aids at least a proportion of alkali metal sulfates or alkali metal sulfites, which are not known per se to improve the tensile adhesion strengths of building products after heat aging.

WO21239234 improves the storage stability of polymer powders through the addition of alkali metal sulfates or magnesium sulfate, but uses the established water-soluble organic polymers in the customary amounts as drying aids. US2007037925 has the aim of providing mortars having accelerated setting and teaches for this purpose the addition of polymer powder compositions modified with alkali metal salts or alkaline earth metal salts of inorganic or organic acids. Here too, the customary water-soluble organic polymers in the usual amounts are employed as drying aids. WO2017/178422 discloses aqueous polymer dispersions comprising drying aids and water-soluble salts a) of polyvalent metals, such as alkaline earth metals, aluminum, zirconium, iron or zinc, and additionally water-soluble salts b) of anions such as aluminates, silicates, borates, sulfates or carbonates, wherein the polyvalent metals of the salts a) form water-insoluble salts with the anions of the salts b), and subsequent drying results in the water-insoluble salts formed from the salts a) and b) forming a shell on the polymer particles that dissolves only in alkaline media or as a result of mechanical stress. The proportion of the inorganic shell is 10% to 50% by weight or 10% to 20% by weight, based on the polymer core. The shell of the water-insoluble salts counteracts the caking of the polymer particles and acts as an antiblocking agent.

The polymerization of ethylenically unsaturated monomers is normally initiated by means of initiators, for example alkali metal persulfates. As is known, the initiators decompose into free radicals that add to ethylenically unsaturated monomers, thereby initiating polymer chain growth. As a result of this, the initiators become attached via covalent bonds to the polymers formed in the course of the polymerization and are consequently not present in the polymer dispersion in the form of inorganic low-molecular-weight compounds such as alkali metal sulfates or are present only in an insignificant amount.

The invention provides processes for producing protective-colloid-stabilized polymers based on ethylenically unsaturated monomers, in the form of water-redispersible powders (polymer powders),
by drying aqueous dispersions of protective-colloid-stabilized polymers based on ethylenically unsaturated monomers (polymer dispersions) in the presence of one or more drying aids, characterized in that
the drying aids include a) one or more inorganic salts selected from the group of alkali metal sulfates and alkali metal sulfites and b) optionally one or more water-soluble organic polymers and
the inorganic salts a) are present in the polymer dispersions in dissolved form after all drying aids have been added,
wherein the inorganic salts a) are employed as drying aids to an extent of ≥25% by weight based on the total weight of the drying aids, and
wherein the proportion of any water-soluble organic polymers b) employed as drying aids is ≤40% by weight based on the total weight of protective colloids and any water-soluble organic polymers b) employed as drying aids.

The invention further provides protective-colloid-stabilized polymers based on ethylenically unsaturated monomers in the form of water-redispersible powders (polymer powders) obtainable by the abovementioned process according to the invention.

The inorganic salts a) employed as drying aids are preferably selected from the group comprising lithium sulfate (Li₂SO₄), sodium sulfate (Na₂SO₄), potassium sulfate (K₂SO₄), lithium sulfite (Li₂SO₃), sodium sulfite (Na₂SO₃), and potassium sulfite (K₂SO₃). Particular preference is given to sodium sulfate, sodium sulfite, potassium sulfate, and potassium sulfite. Most preferred are sodium sulfate and sodium sulfite. Sulfates are more preferred here.

The inorganic salts a) are present in the polymer dispersions in dissolved form after all drying aids have been added. The inorganic salts a) are present in the polymer dispersions in dissolved form preferably after the total amount of all drying aids have been added. The inorganic salts a) are generally present in the polymer dispersions in dissolved form before drying and/or at the start of drying. However, this does not preclude proportions of the inorganic salts a) being present in the polymer dispersions in undissolved form, for example adhering to a constituent of the polymer dispersions. Preferably, at least the major part of the inorganic salts a) is present in the polymer dispersions in dissolved form. More preferably, >50% by weight, even more preferably ≥70% by weight, particularly preferably ≥90% by weight, and most preferably ≥99% by weight, of the inorganic salts a) are present in the polymer dispersions in dissolved form, based on the total weight of the inorganic salts a) introduced into the polymer dispersions as drying aids. Most preferably of all, the inorganic salts a) introduced as drying aids are present in the polymer dispersions entirely in dissolved form. All of this is generally applicable also to the situation where, in addition to the inorganic salts a), further organic or especially inorganic salts are introduced into the polymer dispersions or are present in the polymer dispersions. When two or more inorganic salts a) are introduced into the polymer dispersions, these salts generally do not result in the formation of insoluble salts.

A measure and a method according to the invention for determining the solubility of the inorganic salts a) in the polymer dispersions is their solubility in water. The inorganic salts a) or, when further organic or especially inorganic salts are used, mixtures thereof with the inorganic salts a), have a water solubility of preferably ≥1 g per liter of water, more preferably ≥3 g per liter of water, even more preferably ≥10 g per liter of water, particularly preferably ≥50 g per liter of water, and most preferably ≥100 g per liter of water, in each case under standard conditions (23° C./50% relative humidity) according to DIN50014. These values relate preferably to neutral pH values, i.e. pH 7.

The polymer dispersions and/or the polymer powders contain preferably 0.1% to 20% by weight, more preferably 0.2% to 10% by weight, even more preferably 0.3% to 5% by weight, even more preferably 0.4% to 4% by weight, particularly preferably 0.5% to 3%, most preferably 1% to 2% by weight, and most preferably of all 1.1% to 2% by weight, of inorganic salts a) based on the total weight of the polymers based on ethylenically unsaturated monomers.

The proportion of the inorganic salts a) based on the total weight of the protective colloids is preferably 2% to 50% by weight, more preferably 3% to 30% by weight, and most preferably 5% to 20% by weight.

The proportion of the inorganic salts a) based on the total weight of the protective colloids and of the water-soluble organic polymers b) is preferably 2% to 50% by weight, more preferably 3% to 30% by weight, and most preferably 5% to 20% by weight.

The proportion of the inorganic salts a) based on the total weight of the drying aids is preferably >25% by weight, more preferably ≥30% by weight, even more preferably ≥40% by weight, even more preferably ≥50% by weight, even more preferably ≥60% by weight, and particularly preferably ≥80% by weight.

Most preferably, exclusively inorganic salts a) are employed as drying aids.

When the polymer dispersions comprise salts, especially cations, that form water-insoluble salts with the anions of the inorganic salts a), especially sulfate, the above % by weight values for the amounts of inorganic salts a) according to the invention are preferably based on the proportions of the inorganic salts a) present in the polymer dispersions in dissolved form. This is especially preferably the case when the polymer dispersions contain cations of alkaline earth metals, aluminum, zirconium, iron or zinc.

The water-soluble organic polymers b) employed as drying aids have a water solubility of preferably ≥1 g per liter of water, more preferably ≥3 g per liter of water, and most preferably ≥10 g per liter of water, in each case under standard conditions (23° C./50% relative humidity) according to DIN50014. These values relate preferably to neutral pH values, i.e. pH 7.

Examples of water-soluble organic polymers b) suitable as drying aids are polyvinyl alcohols, polyvinyl acetals, nonionic polyvinylpyrrolidones, nonionic poly(meth)acrylamides, polysaccharides, and proteins. Said water-soluble organic polymers b) are obtainable by processes known to those skilled in the art. Preference is given here to nonionic water-soluble organic polymers b). Nonionic water-soluble organic polymers b), especially nonionic polyvinylpyrrolidones and nonionic poly(meth)acrylamides, generally do not contain any ionic monomer units and generally do not bear any ionic groups, especially no ammonium, carboxylic acid or sulfonic acid groups. The nonionic polyvinylpyrrolidones consist preferably of vinylpyrrolidone units. Nonionic poly(meth)acrylamides consist preferably of (meth)acrylamide units.

Greater preference is given to polyvinyl alcohols; polyvinyl acetals; polysaccharides, especially in water-soluble form such as starches (amylose and amylopectin), celluloses or derivatives thereof such as carboxymethyl, methyl, hydroxyethyl or hydroxypropyl derivatives; and proteins such as casein or caseinate, soy protein, and gelatin. Particular preference is given to polyvinyl alcohols. Most preferably, aside from polyvinyl alcohols, no further water-soluble organic polymer b) is used as drying aid.

Preferred polyvinyl alcohols are partially or fully hydrolyzed polyvinyl alcohols having a degree of hydrolysis of preferably 80 to 100 mol %. Particular preference is given to partially hydrolyzed polyvinyl alcohols having a degree of hydrolysis of 80 to 95 mol %, especially having a Höppler viscosity in a 4% aqueous solution of 1 to 30 mPa·s (Höppler method at 20° C., DIN 53015). Greatest preference is given to polyvinyl alcohols having a degree of hydrolysis of 85 to 94 mol %, especially having a Höppler viscosity in a 4% aqueous solution of 3 to 15 mPa·s (Höppler method at 20° C., DIN 53015).

The polymer dispersions and/or the polymer powders contain preferably ≤15% by weight, more preferably ≤10% by weight, even more preferably ≤5% by weight, even more preferably ≤3% by weight, particularly preferably ≤0.9%, and very particularly preferably ≤0.5% by weight, of water-soluble organic polymers b) as drying aids, based on the total weight of the polymers based on ethylenically unsaturated monomers.

The polymer dispersions and/or the polymer powders contain preferably <40% by weight, more preferably ≤30% by weight, even more preferably ≤20% by weight, even more preferably ≤10% by weight, particularly preferably ≤5%, and most preferably ≤1% by weight, of water-soluble organic polymers b) as drying aids, based on the total weight of the protective colloids.

The polymer dispersions and/or the polymer powders contain preferably <40% by weight, more preferably ≤30% by weight, even more preferably ≤20% by weight, even more preferably ≤10% by weight, particularly preferably ≤5%, and most preferably ≤1% by weight, of water-soluble organic polymers b) as drying aids, based on the total weight of the protective colloids and any water-soluble organic polymers b).

The proportion of the water-soluble organic polymers b) as drying aids is preferably ≤70% by weight, more preferably ≤50% by weight, even more preferably ≤30% by weight, particularly preferably ≤10% by weight, very particularly preferably ≤5% by weight, based on the total weight of the drying aids.

Most preferably of all, no water-soluble organic polymers b) are employed as drying aids.

Any water-soluble organic polymers b) employed as drying aids are generally added to the polymer dispersions, i.e. usually after production of said polymer dispersions by polymerization. Water-soluble organic polymers b) employed as drying aids are thus generally used after the end of the polymerization. As is known, the end of polymerization is perceptible, for example, by the decline in the evolution of heat by the polymerization batch. After the end of polymerization, the polymerization batch generally no longer evolves heat. Consequently, there is generally also no addition to the polymer dispersions of ethylenically unsaturated monomers, protective colloids or initiators after production of said polymer dispersions by polymerization. The addition of the water-soluble organic polymers b) employed as drying aids thus takes place especially after degassing the polymerization batch or releasing excess pressure therefrom, or after postpolymerization, or after the removal of residual monomers, or else preferably after finishing of the polymer dispersions, i.e. after addition of additives such as preservatives or defoamers.

On the other hand, protective colloids are, as is known, generally present during the polymerization. The addition of the protective colloids thus generally takes place before or during the polymerization, or before or during addition of the monomers or initiators, especially before addition of the monomers or initiators is complete. The addition of the protective colloids thus also generally takes place before removal of residual monomers, or before postpolymerization, i.e. generally before the end of polymerization.

These process steps are inevitably reflected in the structural properties of the polymer powders. For example, protective colloids and water-soluble organic polymers b) employed as drying aids are generally, as is known, incorporated into the polymer powders in an entirely different manner and fulfill completely different functions, and differences in the type, or mode of addition, of protective colloids and drying aids thus give rise to differences in the process and also differences in the material properties of the polymer powders.

Thus, protective colloids generally stabilize the polymerization batch during the polymerization in an aqueous medium and also the polymer particles formed in the course of the polymerization. The polymer particles formed in the course of the polymerization are also referred to as primary particles. Protective colloids are generally incorporated into the primary particles or physically or chemically bound into the primary particles, preferably irreversibly, for example by physical entanglement or by covalent bonding, or encapsulated by the polymers formed in the course of the polymerization.

On the other hand, water-soluble organic polymers b) employed as drying aids are not generally incorporated into the primary particles. The addition, after the polymerization, of the water-soluble organic polymers b) employed as drying aids generally results in the primary particles becoming encased therewith. The pulverulent particles formed during drying are also referred to as secondary particles. After the aqueous polymer dispersions have been dried, the polymer primary particles will generally be encased in a shell of drying aid, as a result of which the primary particles are generally isolated from one another; this has the advantageous effect that the individual primary particles do not undergo irreversible agglomeration. After redispersion of the polymer powders in water, primary particles are generally released again. Drying aids are generally also present at the interface between the particles and air, whereas protective colloids are generally absent.

Because the water-soluble organic polymers b) employed as drying aids are generally added after the polymerization, said water-soluble organic polymers b) generally also do not undergo modification through a free-radical-initiated polymerization, for example by grafting reactions or oxidation or reduction reactions by initiators, such as redox initiators, or by hydrolysis, such as hydrolysis of acetate units from partially hydrolyzed polyvinyl alcohols. Grafting reactions, as is known, attach chemical groups such as monomers to polymers, generally via covalent bonds. Grafting reactions occur to a particularly high degree in the polymerization of vinyl acetate and/or ethylene. Protective colloids, on the other hand, are generally able to undergo such modifications as a consequence of their presence during the polymerization.

In the course of the polymerization, polymerization auxiliaries or additives such as initiators are likewise either attached directly to the polymer chains via covalent bonds or incorporated into the polymer particles or encapsulated by the polymers.

The polymers of ethylenically unsaturated monomers (base polymers) are based for example on one or more monomers selected from the group comprising vinyl esters, (meth)acrylic esters, vinylaromatics, olefins, 1,3-dienes, and vinyl halides.

Suitable vinyl esters are for example those of carboxylic acids having 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 carbon atoms, for example VeoVa9R or VeoVa10R (trade names of Resolution). Particular preference is given to vinyl acetate.

Suitable monomers from the group of acrylic esters or methacrylic esters are for example esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, and 2-ethylhexyl acrylate. Particular preference is given to methyl acrylate, methyl methacrylate, n-butyl acrylate, t-butyl acrylate, and 2-ethylhexyl acrylate.

Preferred vinylaromatics are styrene, methylstyrene, and vinyltoluene. A preferred vinyl halide is vinyl chloride. The preferred olefins are ethylene and propylene, and the preferred dienes are 1,3-butadiene and isoprene.

It is optionally also possible to copolymerize 0% to 10% by weight, preferably 0.1% to 5% by weight, based on the total weight of the monomers, of auxiliary monomers. Examples of auxiliary monomers are ethylenically unsaturated mono- and dicarboxylic acids, preferably acrylic acid, methacrylic acid, fumaric acid, and maleic acid; ethylenically unsaturated carboxamides and carbonitriles, preferably acrylamide and acrylonitrile; mono- and diesters of fumaric acid and maleic acid, such as the diethyl and diisopropyl esters, and maleic anhydride; ethylenically unsaturated sulfonic acids or salts thereof, preferably vinylsulfonic acid, and 2-acrylamido-2-methylpropanesulfonic acid. Further examples are precrosslinking comonomers such as polyethylenically unsaturated comonomers, for example diallyl phthalate, divinyl adipate, diallyl maleate, allyl methacrylate or triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide, N-methylolallyl carbamate, and alkyl ethers such as the isobutoxy ether or esters of N-methylolacrylamide, of N-methylolmethacrylamide, and of N-methylolallyl carbamate. Also suitable are epoxy-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes, and vinylmethyldialkoxysilanes, where the alkoxy groups present may for example be ethoxy and ethoxypropylene glycol ether radicals. These also include monomers having hydroxy or CO groups, for example hydroxyalkyl methacrylates and hydroxyalkyl acrylates such as hydroxyethyl, hydroxypropyl or hydroxybutyl acrylate or methacrylate, and compounds such as diacetone acrylamide and acetylacetoxyethyl acrylate or methacrylate.

In an alternative, preferred embodiment, no ethylenically unsaturated mono- and dicarboxylic acids, no mono- and diesters of fumaric acid and maleic acid, no maleic anhydride and/or no ethylenically unsaturated sulfonic acids are incorporated by polymerization into the copolymers. Particularly preferably, no auxiliary monomers are incorporated by polymerization into the copolymers.

Styrene-(meth)acrylic ester copolymers and especially vinyl acetate-ethylene copolymers are preferred.

The polymer powders preferably contain 50% to 90% by weight of vinyl acetate-ethylene copolymers and/or styrene-(meth)acrylic ester copolymers, based on the total weight of the polymer powders.

Preference is given to copolymers of vinyl acetate with 1% to 50% by weight of ethylene; copolymers of vinyl acetate with 1% to 50% by weight of ethylene and 1% to 50% by weight of one or more further comonomers from the group of vinyl esters having 1 to 12 carbon atoms in the carboxyl radical, such as vinyl propionate, vinyl laurate, vinyl esters of alpha-branched carboxylic acids having 9 to 13 carbon atoms, such as VeoVa9, VeoVa10, VeoVa11; copolymers of vinyl acetate, 1% to 50% by weight of ethylene and preferably 1% to 60% by weight of (meth)acrylic esters of unbranched or branched alcohols having 1 to 15 carbon atoms, especially n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 carbon atoms, and also 1% to 30% by weight of (meth)acrylic esters of unbranched or branched alcohols having 1 to 15 carbon atoms, especially n-butyl acrylate or 2-ethylhexyl acrylate, which also contain 1% to 40% by weight of ethylene; copolymers with vinyl acetate, 1% to 50% by weight of ethylene, and 1% to 60% by weight of vinyl chloride; where the polymers may also contain the auxiliary monomers mentioned in the amounts mentioned, and where the figures in % by weight add up to 100% by weight in each case.

Preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, and 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate, and optionally ethylene; styrene-1,3-butadiene copolymers; where the polymers may also contain the auxiliary monomers mentioned in the amounts mentioned, and where the figures in % by weight add up to 100% by weight in each case.

Most preferred are copolymers with vinyl acetate and 5% to 50% by weight of ethylene; or copolymers with vinyl acetate, 1% to 50% by weight of ethylene, and 1% to 50% by weight of a vinyl ester of α-branched monocarboxylic acids having 9 to 11 carbon atoms; or copolymers with 30% to 75% by weight of vinyl acetate, 1% to 30% by weight of vinyl laurate or vinyl esters of an alpha-branched carboxylic acid having 9 to 11 carbon atoms, and also 1% to 30% by weight of (meth)acrylic esters of unbranched or branched alcohols having 1 to 15 carbon atoms, which also contain 1% to 40% by weight of ethylene; or copolymers with vinyl acetate, 5% to 50% by weight of ethylene, and 1% to 60% by weight of vinyl chloride.

The monomers and the proportions by weight of the comonomers are selected so as to result in a glass transition temperature Tg of preferably −50° C. to +35° C., more preferably −30° C. to +25° C., and most preferably −10° C. to +20° C. The glass transition temperature Tg of the polymers can be determined in a known manner by differential scanning calorimetry (DSC). The Tg can also be predicted approximately by the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in kelvin of the homopolymer of the monomer n. Tg values for homopolymers are listed in Polymer Handbook 2nd Edition, J. Wiley & Sons, New York (1975).

The polymers are preferably obtainable by emulsion polymerization or suspension polymerization of one or more ethylenically unsaturated monomers in an aqueous medium. The polymers are preferably produced by the emulsion polymerization process.

The polymerization temperature is preferably between 40° C. and 110° C., more preferably between 60° C. and 90° C. In the copolymerization of gaseous comonomers such as ethylene, 1,3-butadiene or vinyl chloride, it is also possible to work under pressure, generally between 5 bar and 100 bar.

The polymerization is initiated with the water-soluble or monomer-soluble initiators or redox initiator combinations customarily used for emulsion polymerization or suspension polymerization. Examples of water-soluble initiators are the sodium, potassium, and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide, and azobisisobutyronitrile. Examples of monomer-soluble initiators are dicetyl peroxydicarbonate, dicyclohexyl peroxydicarbonate, and dibenzoyl peroxide. The initiators mentioned are generally used in an amount of 0.01% to 1.0% by weight, preferably 0.0015% to 0.7% by weight, more preferably 0.002% to 0.4% by weight, and most preferably 0.0025% to 0.3% by weight, in each case based on the total weight of the monomers.

The redox initiators used are combinations of the initiators mentioned and reductants. Suitable reductants are the sulfites and bisulfites of alkali metals and of ammonium, for example sodium sulfite, derivatives of sulfoxylic acid such as zinc or alkali metal formaldehyde sulfoxylates, for example sodium hydroxymethanesulfinate, and ascorbic acid. The amount of reductant is generally 0.001% to 1.0% by weight, preferably 0.0015% to 0.7% by weight, more preferably 0.002% to 0.4% by weight, and most preferably 0.0025% to 0.3% by weight, in each case based on the total weight of the monomers.

Substances that act as chain-transfer agents may be used during the polymerization to control the molecular weight. When chain-transfer agents are used, they are usually used in amounts of between 0.01% to 5.0% by weight, based on the monomers to be polymerized, and are metered in separately or else in the form of a premix with reaction components. Examples of such substances are n-dodecyl mercaptan, tert-dodecyl mercaptan, mercaptopropionic acid, methyl mercaptopropionate, isopropanol, and acetaldehyde.

Suitable protective colloids for the polymerization are the same and correspondingly preferred polymers described hereinabove as water-soluble organic polymers b). Preference is thus given to polyvinyl alcohols.

The protective colloids are added in the polymerization in an amount of preferably 1% to 20% by weight, more preferably 2% to 15% by weight, and most preferably 3% to 10% by weight, based on the total weight of the monomers.

If the polymerization is carried out in the presence of emulsifiers, the amount thereof is 0.5% to 5% by weight based on the amount of monomers. Suitable emulsifiers are anionic, cationic, and nonionic emulsifiers, for example anionic surfactants, such as alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl sulfonates or alkyl aryl sulfonates having 8 to 18 carbon atoms, esters and monoesters of sulfosuccinic acid with monohydric alcohols or alkylphenols, or nonionic surfactants such as alkyl polyglycol ethers or alkylaryl polyglycol ethers having 8 to 40 ethylene oxide units.

The polymerization is particularly preferably carried out in the absence of emulsifiers. The aqueous dispersions and/or the polymer powders preferably do not contain any emulsifiers.

On completion of the polymerization, residual monomers can be removed by postpolymerization employing known methods, generally by redox-catalyst-initiated postpolymerization. Volatile residual monomers can also be removed by distillation, preferably under reduced pressure, and optionally while passing inert entraining gases, such as air, nitrogen or water vapor, through or over.

The polymers thereby obtainable are preferably present in the form of aqueous dispersions, especially protective-colloid-stabilized aqueous dispersions.

The addition of the inorganic salts a) employed as drying aids can take place before, during or preferably after production of the polymers by polymerization. It is also possible to use chemical substances that are converted by chemical reaction into inorganic salts a) of the invention.

For example, the inorganic salts a) may be mixed with the ethylenically unsaturated monomers before initiation of the polymerization. Alternatively, the inorganic salts a) may be added during the polymerization of the ethylenically unsaturated monomers. Similarly, a portion of the inorganic salts a) may be admixed with the ethylenically unsaturated monomers before initiation of the polymerization and the remaining portion of the inorganic salts a) added during the polymerization of the ethylenically unsaturated monomers.

Preferably, the addition of the inorganic salts a) to the corresponding polymer dispersion takes place at the end of the polymerization. More preferably, the addition of the inorganic salts a) takes place before the drying of the aqueous polymer dispersion. For this, preferably one or more inorganic salts a) are added to the aqueous polymer dispersions in order to then dry the resulting mixtures. During the drying of the aqueous polymer dispersions it is preferable that no inorganic salts a) are added.

Any water-soluble organic polymers b) employed as drying aids are generally added to the polymer dispersions, for example spatially or temporally alongside the inorganic salts a) or separately from the inorganic salts a).

The polymer dispersions may be dried for example by fluidized-bed drying, freeze drying or spray drying. The dispersions are preferably spray-dried. Spray drying is carried out in standard spray-drying systems, with atomization being able to be performed by means of one-, two- or multiphase nozzles or with a rotating disk. The chosen outlet temperature is generally in the range of 45° C. to 120° C., preferably 60° C. to 90° C., depending on the system, Tg of the resin, and desired degree of drying. The viscosity of the feed to be atomized is set via the solids content such that a value of preferably <10 000 mPa·s, more preferably <5000 mPa·s, and particularly preferably <1000 mPa·s, is obtained (Brookfield viscosity at 20 revolutions and 23° C.). The solids content of the dispersion to be atomized is preferably from 30% to 75% by weight and more preferably from 50% to 60% by weight.

A content of up to 1.5% by weight of defoamer, based on the polymer, has proven advantageous in many cases. Defoamer is preferably added during atomization.

To increase the storage stability by improving the blocking stability, particularly in the case of polymer powders having a low glass transition temperature, the polymer powder obtained may be provided for example with one or more antiblocking agents (anticaking agents). The antiblocking agents are preferably added not to the aqueous polymer dispersions, i.e. preferably not before drying, but preferably during or after drying, especially during drying in the spray-drying system. Preferred polymer powders comprise antiblocking agents, especially 1% to 30% by weight based on the total weight of polymeric constituents. Examples of antiblocking agents are calcium carbonate or magnesium carbonate, talc, gypsum, silica, kaolins such as metakaolin, and silicates, preferably having particle sizes within the range from 10 nm to 10 μm. Antiblocking agents are usually water-insoluble.

To improve the performance properties, further additives may be added during drying. Further constituents of polymer powders that are present in preferred embodiments are for example pigments, fillers, foam stabilizers, hydrophobizing agents or cement plasticizers.

The polymer powders preferably do not contain any polyelectrolytes. Polyelectrolytes refer generally to polymers having groups capable of dissociating into ions in an aqueous medium and that may be a constituent or substituent of the polymer chain. The number of groups capable of dissociating into ions is generally so large that the polymers are in the dissociated form completely soluble in water. Polyelectrolytes may be for example polyacids or polybases.

The polymer powders preferably contain no water-soluble halide salts, especially no water-soluble chloride salts. Water-soluble halide salts have a water solubility of preferably ≥1 g per liter of water under standard conditions (23/50) as per DIN50014.

The polymer powders preferably contain no polyfunctional alcohols, especially no alcohols bearing at least one alcohol group and optionally one or more further functional groups selected from the group comprising amine, carbamic acid, mercaptan, sulfonic acid, sulfuric acid, halide, carboxyl, alkoxy, phosphinic acid, phosphonic acid, and phosphoric acid groups, where the sum of the number of alcohol groups and of the further functional groups of the alcohols is ≥2. The polymer powders preferably contain no alcohols having ≤20, more preferably ≤15 carbon atoms or >2 carbon atoms.

The polymer powders preferably contain no polyalkylene polyamine, especially no polyethyleneimine, especially none having a molecular weight of 300 to 10 000 000. Polyalkylene polyamines are generally based on ethylenically unsaturated monomers bearing amine, ammonium or amide groups and optionally further ethylenically unsaturated monomers.

Preferably, no salts of polyvalent metals are added to the polymer dispersions, especially no salts of magnesium, calcium, barium, aluminum, zirconium, iron or zinc.

The invention further provides building material dry formulations comprising one or more hydraulically setting binders, one or more fillers, one or more polymer powders of the invention, and optionally one or more additives.

The building material dry formulations contain preferably 0.1% to 30% by weight, more preferably 0.3% to 12.0% by weight, and most preferably 0.5% to 5.0% by weight, of polymer powders of the invention, in each case based on the total weight of the building material dry formulations.

Examples of suitable hydraulically setting binders are cements, especially portland cement, aluminate cement, trass cement, slag cement, magnesia cement, phosphate cement or blast furnace cement, and also mixed cements, filling cements, fly ash, microsilica, hydraulic lime, and gypsum. Preference is given to portland cement, aluminate cement, and slag cement and also to mixed cements, filling cements, hydraulic lime, and gypsum. Preference is also given to mixtures of two or more hydraulically setting binders comprising in particular cement and hydraulic lime.

In general, the building material dry formulations contain 5% to 50% by weight, preferably 10% to 30% by weight, of hydraulically setting binders, in each case based on the total weight of the building material dry formulations.

Examples of suitable fillers are quartz sand, quartz powder, calcium carbonate, dolomite, aluminum silicates, clay, chalk, white hydrated lime, talc or mica, or also lightweight fillers such as pumice, foam glass, aerated concrete, perlite, vermiculite, and carbon nanotubes (CNT). Any desired mixtures of the stated fillers may also be used. Preference is given to quartz sand, quartz powder, calcium carbonate, chalk or hydrated white lime. Fillers are generally/implicitly insoluble in water.

In general, the building material dry formulations contain 30% to 90% by weight, preferably 40% to 85% by weight, of fillers, in each case based on the total weight of the building material dry formulations.

Other customary additives for the building material dry formulations are thickeners, for example polysaccharides, such as cellulose ethers and modified cellulose ethers, starch ethers, guar gum, xanthan gum, sheet silicates, polycarboxylic acids, such as polyacrylic acid and partial esters thereof, and also polyvinyl alcohols, which may optionally be acetalized or hydrophobically modified, casein, and associative thickeners. Customary additives are also retarders such as hydroxycarboxylic acids or dicarboxylic acids or salts thereof, saccharides, oxalic acid, succinic acid, tartaric acid, gluconic acid, citric acid, sucrose, glucose, fructose, sorbitol, and pentaerythritol. A customary additive is setting accelerators, for example alkali metal or alkaline earth metal salts of inorganic or organic acids. Additionally, the following should also be mentioned: hydrophobizing agents, preservatives, film-forming agents, dispersants, foam stabilizers, defoamers, and flame retardants (for example aluminum hydroxide).

The additives are used in the customary amounts, which depend on the nature of the additive. In general, the amounts are from 0.01% to 10% by weight, in each case based on the total weight of the building material dry formulations.

The building material dry formulations are generally produced by mixing and homogenizing one or more hydraulically setting binders, one or more fillers, one or more polymer powders, and optionally one or more additives to form a dry mixture. The production of the building material dry formulations can take place in a conventional manner in conventional apparatuses. The amount of water required to process the building material dry formulations is normally added immediately before application.

The building material dry formulations are suitable, for example, for the production of reinforcing compounds for thermal insulation composite systems, or for the production of adhesives or coating materials. Examples of adhesives are adhesives for thermal insulation panels and soundproofing panels, tile adhesives, and adhesives for bonding wood and wood-based materials. Examples of coating materials are mortars, self-leveling compounds, sealing slurries, screeds, and plasters.

Through addition of the polymer powders of the invention to building material dry formulations, building products having improved tensile adhesion strengths after heat aging are surprisingly obtained. What was particularly surprising here was that this was achieved by using alkali metal sulfates or alkali metal sulfites as drying aids, which are not known per se to improve the tensile adhesion strengths of building products after heat aging.

Advantageously, the tensile adhesion strength after heat aging can be significantly improved even with the use of relatively small amounts of polymer powders of the invention.

The examples that follow serve to further elucidate the invention.

### Production of the Polymer Powders:

The polymer powders were each produced using the same customary polymer dispersion of a vinyl acetate-ethylene copolymer having a glass transition temperature Tg of 17° C. The polymer dispersion was produced in a conventional manner by emulsion polymerization and contained 6% by weight of polyvinyl alcohol as protective colloid.

The amounts of drying aid listed in Table 1 were added to this polymer dispersion.

For all (comparative) examples, the resulting spray feeds were dried in a conventional manner per se, by spray drying, affording a redispersible polymer powder.

20% by weight of anticaking agent was added during spray drying to each of the polymer powders thus produced.

The polymer powders were tested in cementitious tile adhesives of the following formulations:

### Tile Adhesive 1 Containing 3% by Weight of Polymer Powder:

420 g of Milke CEM I
460 g of quartz sand of average particle size
81 g of calcium carbonates
4 g of Tylose
5 g of accelerator
30 g of polymer powder of the respective (comparative) example
310 g of water

### Tile Adhesive 2 Containing 6% by Weight of Polymer Powder:

400 g of Milke CEM I
265.5 g of coarse quartz sand
265.5 g of fine quartz sand
4 g of Tylose
5 g of accelerator
60 g of polymer powder of the respective (comparative) example
270 g of water

The tile adhesives 1 or tile adhesives 2 were applied in a conventional manner. The testing of the tensile adhesion values after heat aging was carried out according to EN1348.

The results of the testing are summarized in Table 1.

TABLE 1

| | | | Tensile adhesion value | |
|---|---|---|---|---|
| | Drying aids | | after heat aging [N/mm²] | |
| | PVOH (04/88)^{a, b)} | Inorganic salt^{a)} | Tile adhesive 1 | Tile adhesive 2 |
| Comp. | — | — | 0.47 | 1.07 |
| ex. 1 | | | | |
| Ex. 2 | — | 1.3 wt % Na₂SO₄ | 1.63 | 2.70 |
| Ex. 3 | — | 1.3 wt % Na₂SO₃ | 1.39 | 2.24 |
| Comp. | 1% by weight | — | 0.60 | 1.26 |
| ex. 4 | | | | |
| Ex. 5 | 1% by weight | 0.6 wt % Na₂SO₄ | 1.44 | 2.13 |
| Ex. 6 | 1% by weight | 1.3 wt % Na₂SO₄ | 1.48 | 2.46 |
| Ex. 7 | 1% by weight | 1.3 wt % Na₂SO₃ | 1.48 | 2.31 |

^{a)}% by weight based on the polymer content of the dispersion (solid/solid).
^{b)}PVOH (04/88): Polyvinyl alcohol having a Höppler viscosity of 4 mPa · s and a degree of hydrolysis of 88%.

The test results in Table 1 show that the addition of inorganic salts a) as drying aids improves the tensile adhesion values after heat aging.

1-11. (canceled)

12. A process for producing protective-colloid-stabilized polymers based on ethylenically unsaturated monomers in the form of water-redispersible powders,
by producing aqueous dispersions of protective-colloid-stabilized polymers based on ethylenically unsaturated monomers by polymerization of one or more ethylenically unsaturated monomers in an aqueous medium and drying said dispersions in the presence of one or more drying aids, wherein
the drying aids include a) one or more inorganic salts selected from the group of alkali metal sulfates and alkali metal sulfites and b) optionally one or more water-soluble organic polymers and
the inorganic salts a) are present in the aqueous dispersions of the protective-colloid-stabilized polymers based on ethylenically unsaturated monomers in dissolved form after all drying aids have been added,
wherein the inorganic salts a) are employed as drying aids to an extent of ≥25% by weight based on the total weight of the drying aids, and
wherein the proportion of any water-soluble organic polymers b) employed as drying aids is ≤40% by weight based on the total weight of protective colloids and any water-soluble organic polymers b) employed as drying aids,
with the proviso that the protective colloids are added before or during the polymerization, and
that any water-soluble organic polymers b) employed as drying aids are added to the aqueous dispersions of the protective-colloid-stabilized polymers after production of said aqueous dispersions by polymerization, and
that the protective colloids stabilize the polymerization batch during the polymerization in an aqueous medium and also the polymer particles formed in the course of the polymerization and that the protective colloids are incorporated into the polymer particles formed in the course of the polymerization, and
that any water-soluble organic polymers b) employed as drying aids, as a result of their addition after the polymerization, encase the polymer particles formed in the course of the polymerization.

13. The process for producing protective-colloid-stabilized polymers based on ethylenically unsaturated monomers in the form of water-redispersible powders as claimed in claim 12, wherein 0.1% to 20% by weight of inorganic salts a) are used, based on the total weight of the polymers based on ethylenically unsaturated monomers.

14. The process for producing protective-colloid-stabilized polymers based on ethylenically unsaturated monomers in the form of water-redispersible powders as claimed in claim 12, wherein 2% to 50% by weight of inorganic salts a) are used, based on the total weight of the protective colloids.

15. The process for producing protective-colloid-stabilized polymers based on ethylenically unsaturated monomers in the form of water-redispersible powders as claimed in claim 12, wherein 2% to 50% by weight of inorganic salts a) are used, based on the total weight of the protective colloids and the water-soluble organic polymers b).

16. The process for producing protective-colloid-stabilized polymers based on ethylenically unsaturated monomers in the form of water-redispersible powders as claimed in claim 12, wherein sodium sulfate, sodium sulfite, potassium sulfate and/or potassium sulfite are used as inorganic salts a).

17. The process for producing protective-colloid-stabilized polymers based on ethylenically unsaturated monomers in the form of water-redispersible powders as claimed in claim 12, wherein one or more water-soluble organic polymers b) are selected from the group comprising polyvinyl alcohols, polyvinyl acetals, nonionic polyvinylpyrrolidones, nonionic poly(meth)acrylamides, polysaccharides, and proteins.

18. The process for producing protective-colloid-stabilized polymers based on ethylenically unsaturated monomers in the form of water-redispersible powders as claimed in claim 12, wherein exclusively inorganic salts a) are employed as drying aids.

19. The process for producing protective-colloid-stabilized polymers based on ethylenically unsaturated monomers in the form of water-redispersible powders as claimed in claim 12, wherein in that the inorganic salts a) are employed as drying aids to an extent of ≥40% by weight based on the total weight of the drying aids.

20. A protective-colloid-stabilized polymer based on ethylenically unsaturated monomers in the form of water-redispersible powders obtainable by the process as claimed in claim 12.

21. A protective-colloid-stabilized polymer based on ethylenically unsaturated monomers in the form of water-redispersible powders obtainable by the process as claimed in claim 18.

22. A building material dry formulation comprising one or more hydraulically setting binders, one or more fillers, one or more protective-colloid-stabilized polymers based on ethylenically unsaturated monomers in the form of water-redispersible powders from claim 20 optionally one or more additives.

23. The use of the building material dry formulation from claim 22 for the production of reinforcing compounds for thermal insulation composite systems or for the production of adhesives or coating materials.
